(19) United States
(12) Patent Application Publication
(10) Pub. No.: US 2017/0094945 A1
(43) Pub. Date: Apr. 6, 2017

(54) LEASH WITH COLLAPSIBLE POCKETS

(71) Applicant: Doskocil Manufacturing Company, Inc., Arlington, TX (US)

(72) Inventor: Donielle Gerard SULLIVAN, Solana Beach, CA (US)

(21) Appl. No.: 15/283,514

(22) Filed: Oct. 3, 2016

Related U.S. Application Data
(60) Provisional application No. 62/235,574, filed on Oct. 1, 2015.

(51) Int. Cl. A01K 27/00

(52) U.S. Cl. CPC A01K 27/008; A01K 27/003

(57) ABSTRACT

A leash includes a strap portion, an attachment portion and a collapsible pocket. The strap portion has a side portion and a front portion. The attachment portion is configured to enable the strap portion to be attached to an animal. The collapsible pocket is attached to the strap portion and is configured to be selectively opened along the side portion of the strap portion, the collapsible pocket having a width in a collapsed state that is less than the width of the front portion of the strap portion.

### CROSS REFERENCE TO RELATED APPLICATION

This application claims priority to U.S. Provisional Application Ser. No. 62/235,574, filed Oct. 1, 2015, the entire contents of which are herein incorporated by reference.

### BACKGROUND

Field of Invention

The present invention generally relates to a pet leash. More specifically, the present invention relates to a pet leash with built-in collapsible pockets.

### Background Art

Pet leashes are commonly used by animal owners to restrain their animals, such as animals, while walking them to prevent the animal from straying away from the owner. Leashes can be attached to a collar around the pet's neck or other portion of the pet.

Conventional leashes can have a pocket for receiving articles to be fastened thereto or secured therein. More specifically, the present invention is directed to an animal leash that includes an integral compartment for containing useful articles that may include, without limitation, keys, money, identification, a telephone, and plastic bags.

### SUMMARY

It has been discovered that improved leashes are desired to improve an owner's animal walking experience. As can be understood, animal walking can be an adventure with even the shortest walk and even the smallest animal, and can require some planning and preparation. Animal walkers are generally required to pick up after their pet's waste and should have plenty of clean bags or other waste disposal methods. Accordingly, after cleaning up pet waste, animal walkers can find themselves carrying a soiled bag in their hands. Moreover, many animal walkers bring along animal treats, balls, keys, phones, etc. with them and desire easy and efficient carrying options. Current solutions for these animal-walking challenges are limited, bulky and unpopular. Many walkers use swinging plastic bag dispensers to hold their bag rolls. These can be annoying to have swinging from your leash and do not offer a solution for the soiled bags. There are an array of soiled bag pouches and attachable pockets for leashes. These solutions are generally clumsy, bulky and unpopular.

It has been found that leashes should be attractive and capable of reflecting an owners personal style, while being functional and safe for handling their animals. In view of the state of the known technology, one aspect of the present disclosure is to provide a leash that includes a strap portion, an attachment portion and a collapsible pocket. The strap portion has a side portion and a front portion. The attachment portion is configured to enable the strap portion to be attached to an animal. The collapsible pocket is attached to the strap portion and is configured to be selectively opened along the side portion of the strap portion, the collapsible pocket having a width in a collapsed state that is less than the width of the front portion of the strap portion.

The improved leash allows for storage when needed and no bulk when not in use. It offers great design finishes, a soft comfortable leash and collapsible pockets that accommodate walking supplies. This leash design can work for all size animals and leash widths and materials and enables safe animal handling with personal style features.

### BRIEF DESCRIPTION OF THE DRAWINGS

Referring now to the attached drawings which form a part of this original disclosure:

FIG. 1 is a top view of the leash with the pockets collapsed and unfilled in the leash handle part;

FIG. 2 is a top view of leash of FIG. 1 with the pockets filled and expanded;

FIG. 3 is a back view of the leash of FIG. 1 with the pockets filled and expanded;

FIG. 4 is an enlarged view of the leash of FIG. 2 with the pockets filled and expanded;

FIG. 5 is an enlarged view of the leash of FIG. 3;

FIG. 6 is an enlarged view of the leash of FIG. 1 with the pocket open and showing generous storage;

FIG. 7 is enlarged view of an open and filled pocket;

FIG. 8 is enlarged view of an open and filled pocket;

FIG. 9 is enlarged view of an open and filled pocket;

FIG. 10 illustrates a collapsible pocket in the trunk of the leash;

FIG. 11 illustrates the leash of FIG. 10 with the pocket in an expanded state;

FIG. 12 is an another embodiment of the present invention showing a pocket disposed on a narrow leash;

FIG. 13 illustrates another embodiment with a removable pocket and a pocket disposed in the handle part;

FIG. 14 shows lower coupling holding a ball and the coupling in the handle part in an open configuration; and

FIG. 15 illustrates an embodiment of a leash segment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

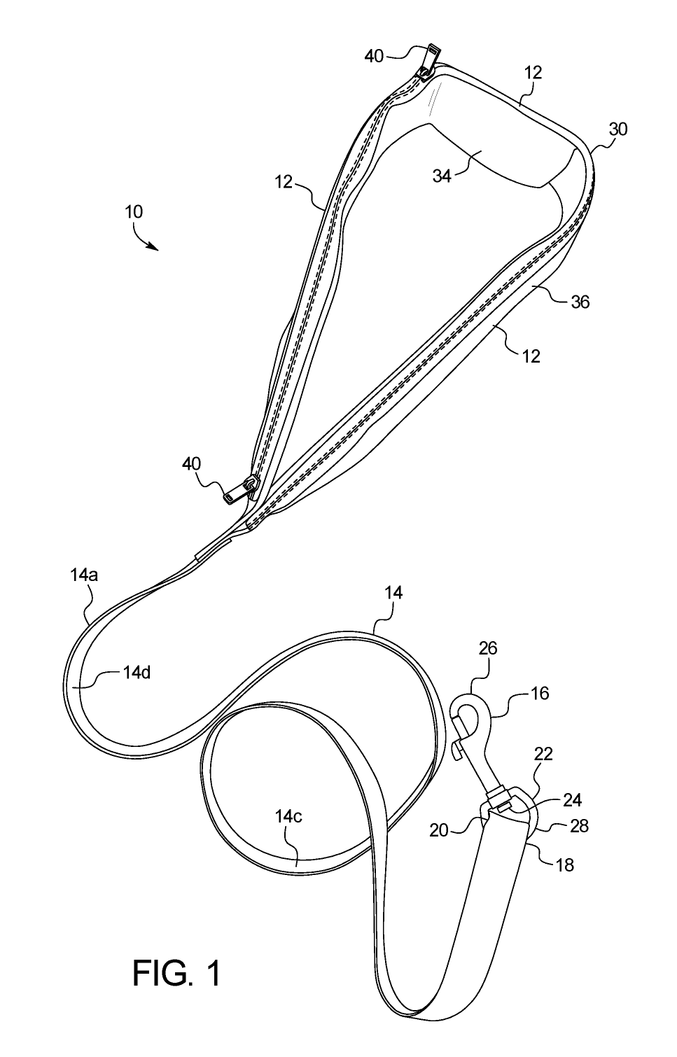

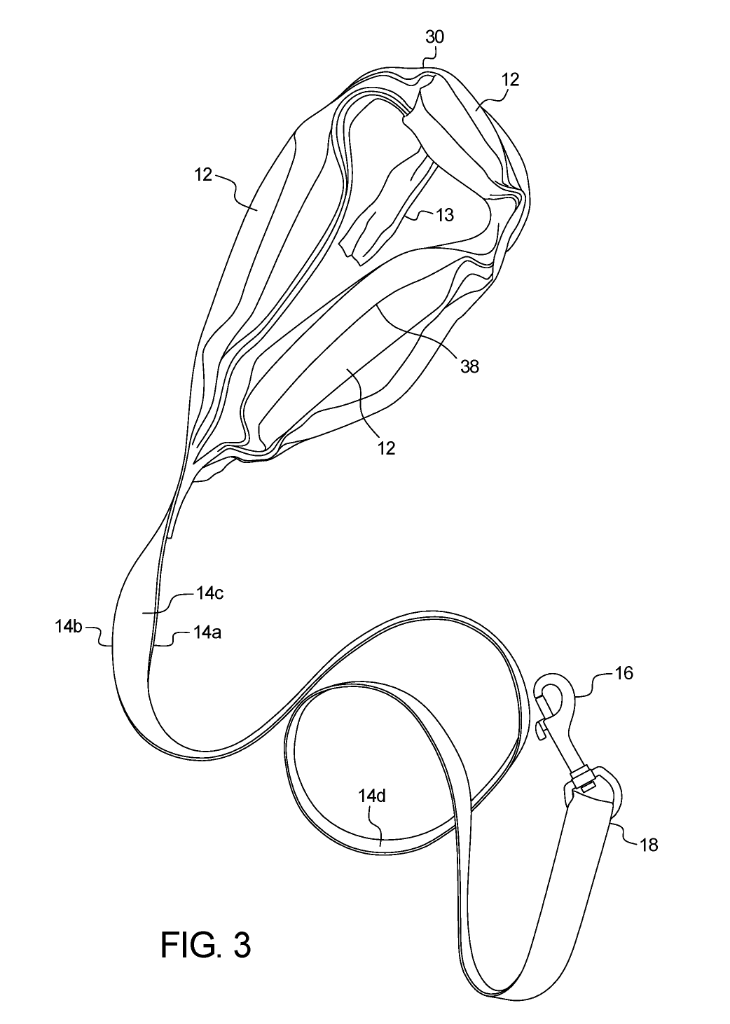

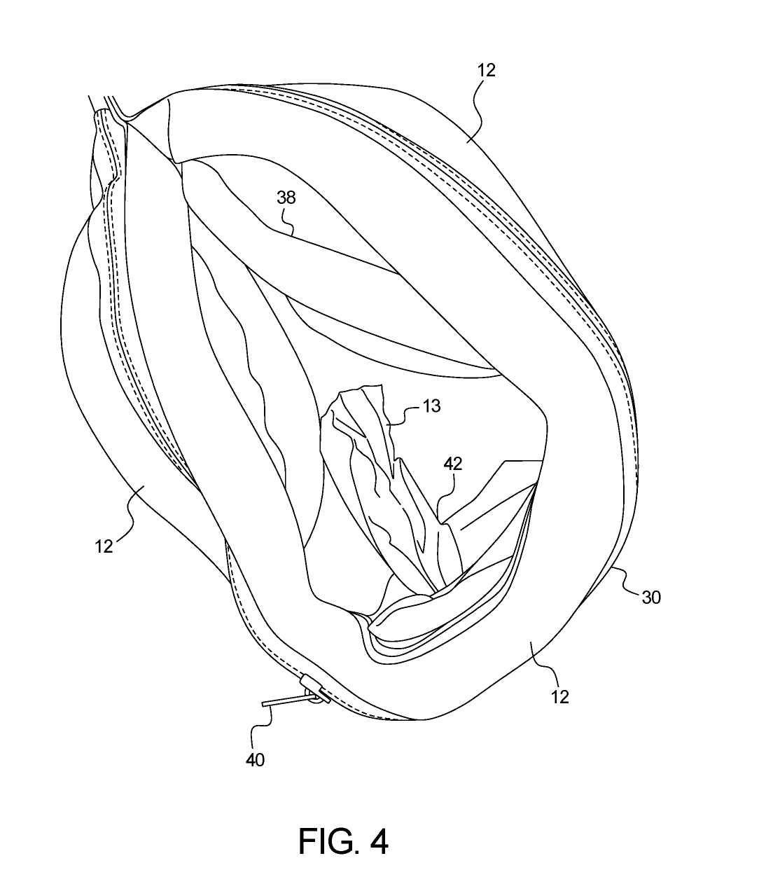

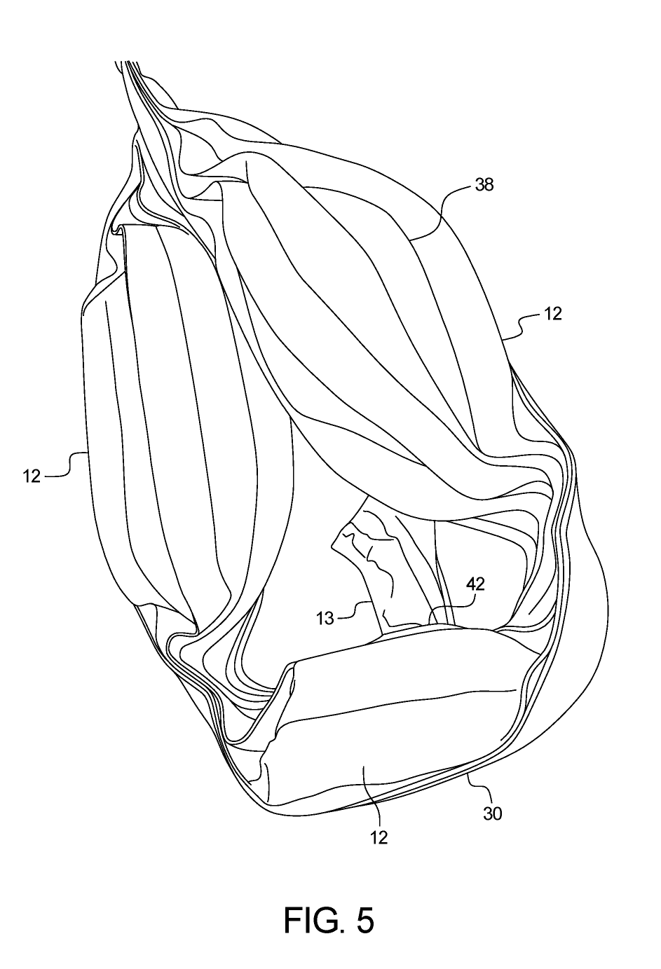

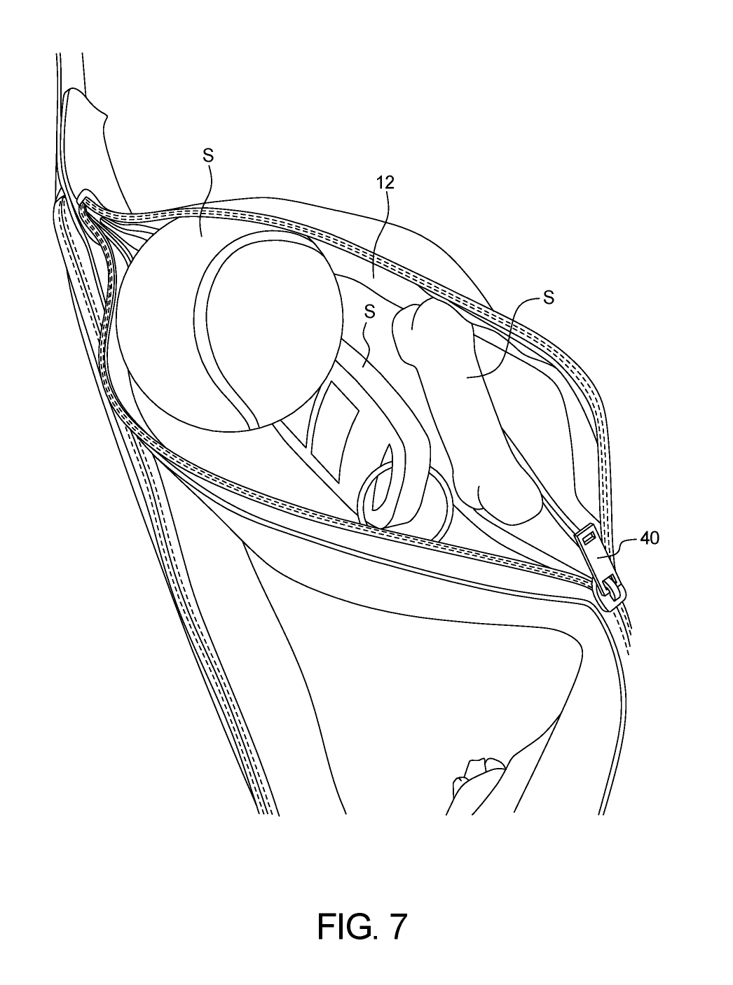

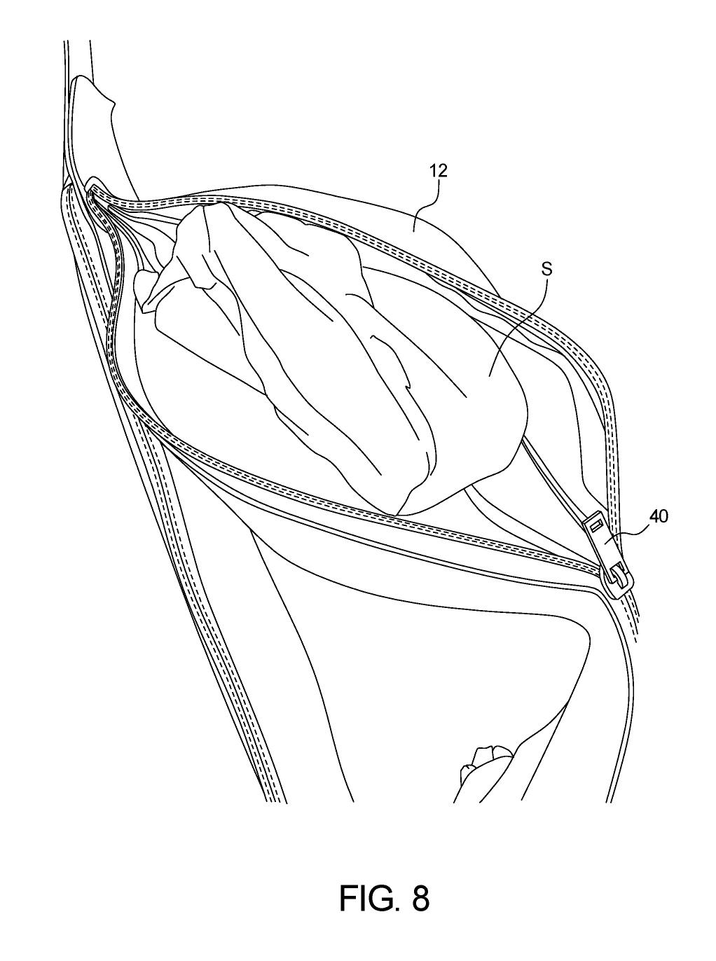

Referring initially to FIGS. 1-9, a leash 10 with built-in collapsible pockets 12 is illustrated. The leash 10 includes a strap portion 14, an attachment portion 16 and a collapsible pocket 12. The leash 10 is generally suitable for walking or restraining animals.

The strap portion 14 can be formed from a strip of material, such as leather or nylon cloth or any other suitable material and has a first end and a second end. The first end 18 can be folded back upon itself and secured by stitching or the like to form a discrete looped opening 20. The strap portion 14 has a first side portion 14a, a second side portion 14b, a front side portion 14c and a rear side portion 14d. The front side portion 14c and the rear side portion 14d are generally parallel and the first side portion 14a and the second side portion 14b are generally parallel. Thus, the first and second side portions 14a and 14b are generally transverse to the front and back side portions 14c and 14d. Moreover, the front and back 14c and 14d side portions have a first width, and the first and second side portions 14a and 14b have a second predetermined width the first predetermined width being greater than the second predetermined width.

As shown in FIGS. 1, the attachment portion 16 can be a snap ring swivel member that is attached to the looped opening 20, and includes a ring portion 22, a swivel portion 24, and a snap portion 26. The inboard end 28 of the ring portion 22 is captively engaged within the looped opening 20 formed on the first end 18 of the strap portion 14. It is noted that the attachment portion 16 can be any suitable device that would enable the strap portion 14 to attach to an animal collar or harness.

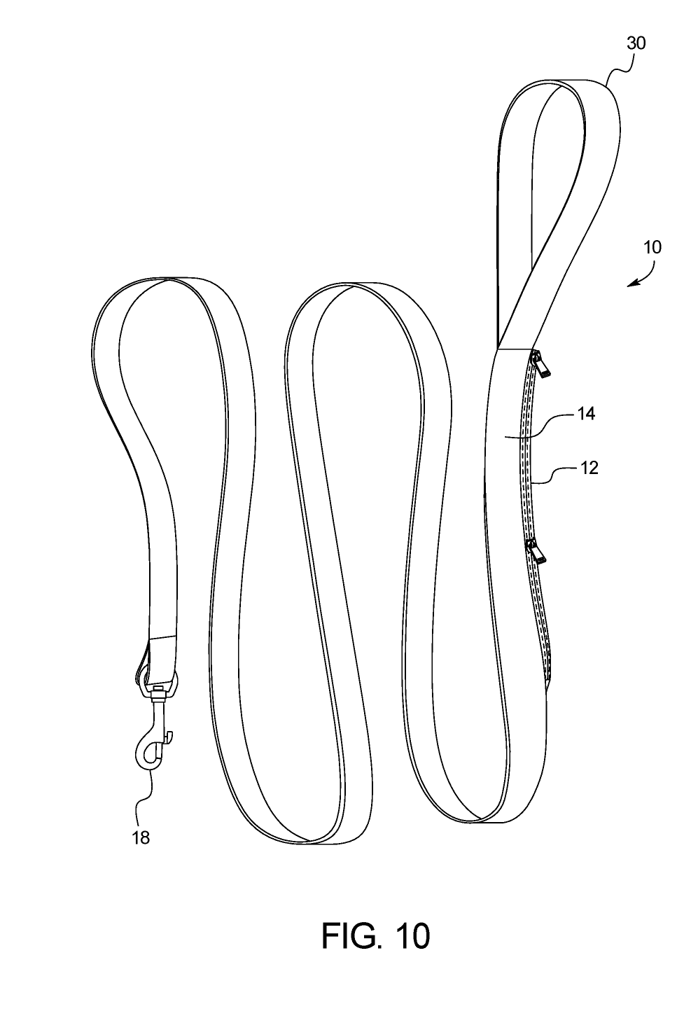

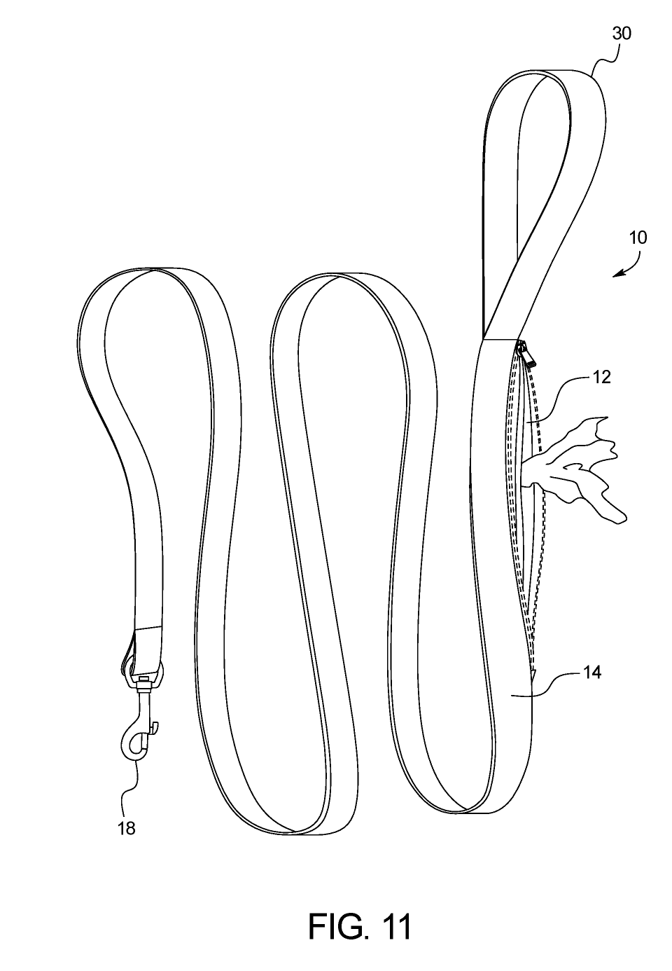

As shown in FIGS. 10 and 11, the collapsible pocket 12 can be disposed in the trunk part 14 of the strap portion. In this embodiment, the pocket 12 enables a user to freely grip the handle while establishing an expansive pocket for holding objects. As seen in FIG. 10, the pocket 12 contour is within the width of the strap portion 14.

A handle part 30 is disposed at the second end 32 of the strap portion 14. The handle part 30 can include a first layer 34 and a second layer 36 and one or more collapsible pockets 12 disposed between the first layer 34 and the second layer 36. In one embodiment, the handle part 30 can be sewn or attached to the strap portion 14; however, the handle part 30 can be attached to the strap portion 14 in any manner desired. For example, the strap portion 14 and handle part 30 can have a contiguous or unitary construction. Thus, in one embodiment, the strap portion 14 and the handle part 30 are formed of first and second layers 34 and 36 attached together. In one embodiment, the first layer 34 can be a designer material or a material that includes aesthetically pleasing indicia, and the second layer can be a durable material, such as rubber or nylon. At the handle part 30 or a portion of the handle part 30, a collapsible pocket 12 or a plurality of collapsible pockets 12 are disposed between the first and second layers.

In one embodiment, the handle part 30 includes three collapsible pockets 12. In this embodiment, the collapsible pockets 12 are disposed in series along the handle part 30, and encompass substantially or approximately the entire length of the handle part 30. However, the collapsible pockets 12 can be disposed along any length of the handle part 30 or strap portion 14 or in parallel or in any suitable or desired manner.

As shown in FIGS. 1-5, the pockets 12 are preferably constructed using nylon accordion pleats 38 that enable the pockets 12 to collapse. That is, the material in the collapsible pocket 12 is formed in a zig zag manner that enables the pocket material to fold upon itself. The accordion pleats 38 of the collapsible pocket 12 can be formed from the same material (i.e., continuous with) the first and second layers of the handle part 30 or they can be made of a separate material and attached in any suitable manner to the first and second layers 34 and 36. Thus, as shown in FIG. 1, when empty, the pockets 12 can be relatively compact. That is, the pockets 12 can have substantially the same width and/or feel as the remainder of the strap portion 14. However, 2-5, when in use, the pockets 12 can expand to accommodate an assortment of storage items or objects S.

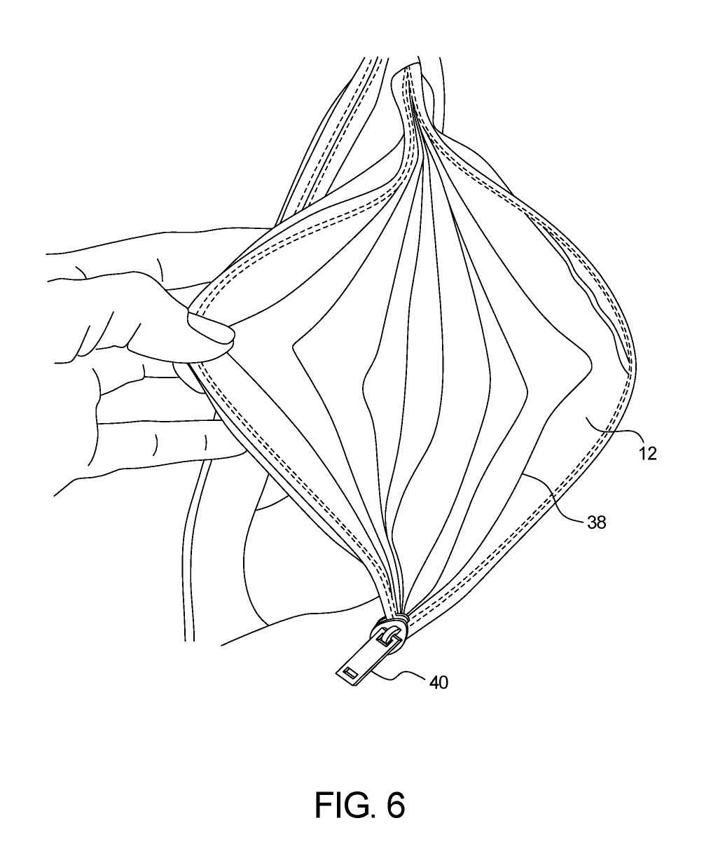

It is noted that the pockets 12 can be constructed in any suitable manner, such as any one or more of a variety of collapsed and extremely expandable fabrics that stretch to accommodate an array of storage items and then collapse down neatly between the first and second leash layers 34 and 36. Thus, as is understood, the pockets 12 are capable of expanding to accommodate an array of storage items S and collapse between the first and second layers 34 and 36 when not in use. See, for example, FIGS. 6-9 illustrating the expandability of the pockets 12, along with various objects positioned therein. Accordingly, the pockets 12 are configured to designed to accommodate significant storage and typically expand at least three times the second predetermined width.

Each of the pockets 12 can be selectively opened and closed by a closure mechanism 40. In one embodiment, the closure mechanism 40 is disposed in at least one of the first and second side portions 14a and 14b of the strap portion 14; however, it is noted that the closure mechanism can be disposed in any suitable or desired position. In one embodiment, the closure mechanism 40 is a zipper that is configured to open a respective pocket 12. That is, each pocket 12 includes a respective (closure mechanism 40) zipper, such that in one embodiment, there a three zippers. Accordingly, each pocket 12 can be zipped and unzipped individually for respective access to the interior of the collapsible pocket 12. In one embodiment, the collapsible pockets 12 are in series and one closure mechanism 40 (e.g., a zipper) is configured to selective open and close all of the collapsible pockets 12. That is, the closure mechanism 40 (e.g., zipper) is configured to traverse from about one end of a first collapsible pocket 12, opening the first pocket 12, then continue to transverse and open the second pocket 12 and then traverse the third pocket 12, until the zipper reaches about the end of the third pocket 12. It is noted that the closure mechanism 40 can be any suitable device, such as zippers, snaps or Velcro.

The unique manufacturing method and structure of the collapsible pockets 12 described herein enable any type of malleable material to form at least one of the strap portion 14, the leash truck or and the handle part 30. For example, the strap portion 14 and/or the handle part 30 can be formed of any suitable material or combination of materials, including but not limited to ribbon, nylon, fabric, rubber or leather to be attached together with collapsible pockets 12 inserted between the first layer 34 and the second layer 36.

As described herein, the construction of the leash 10 offers a permanent collapsible pocket or pockets 12. However, the collapsible pockets 12 can be constructed as removable.

When constructed with removable pockets 12, these inserts are attached between the layers using Velcro or any other coupling material to allow replacement. These removable pockets 12 can be either fabric, malleable plastic or other disposable or washable material.

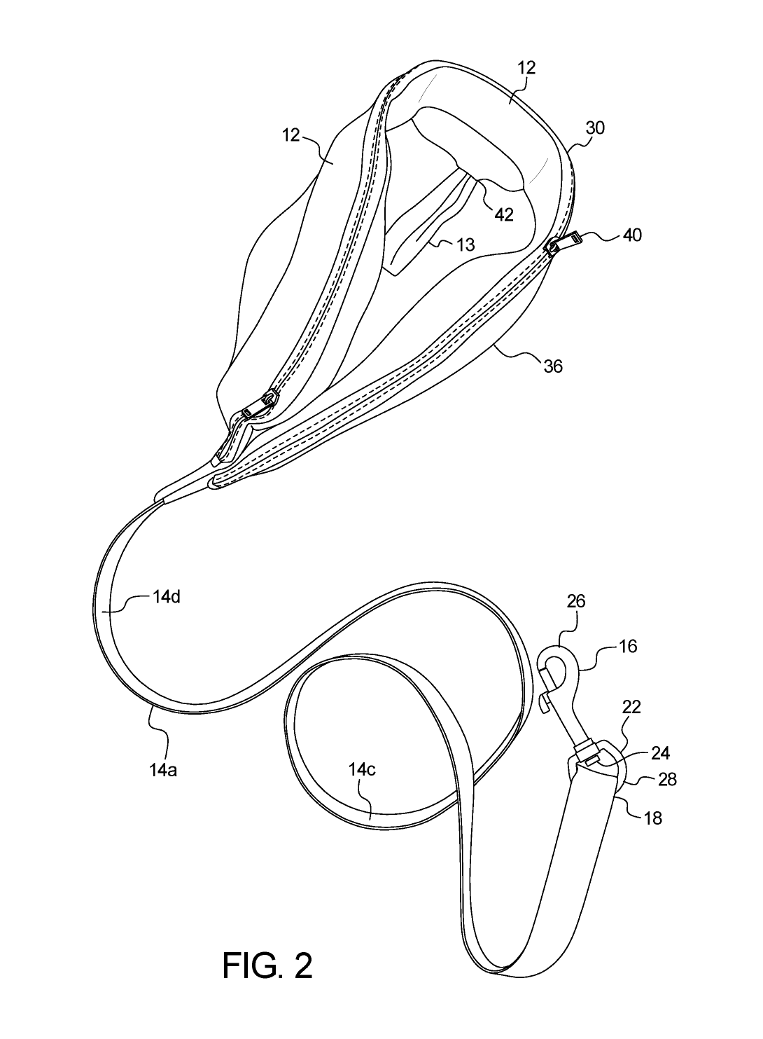

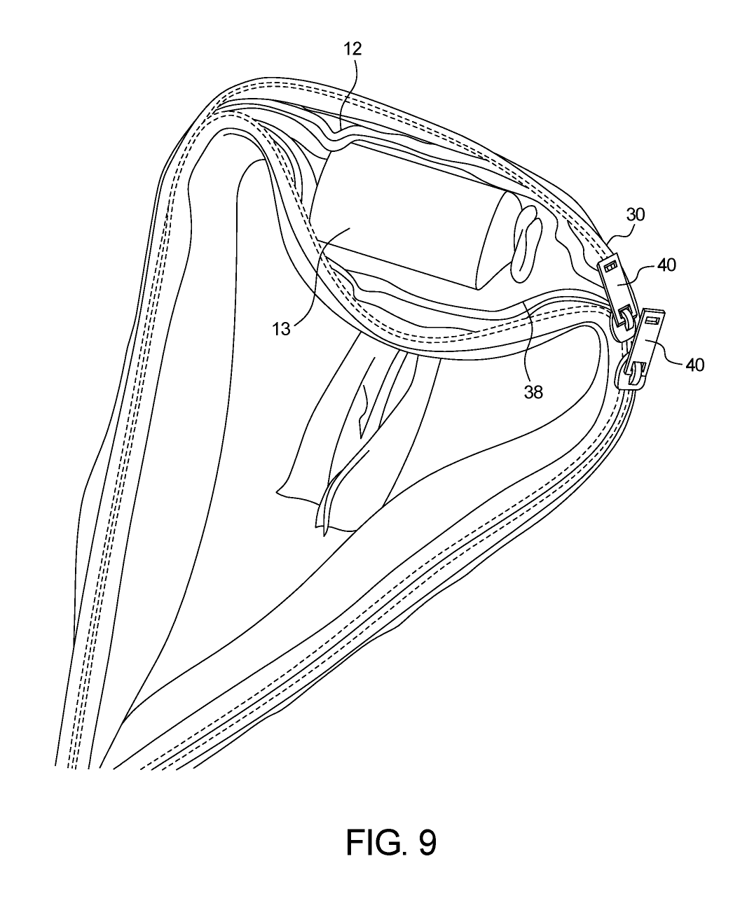

The collapsible pockets 12 provide storage for, but not limited to, unused bag rolls, soiled bags, toys, treats and personal items such as phone, keys, etc. One of the collapsible pockets 12 can be used for unused bag rolls B (FIG. 9) and provides a comfortable leash grip at the back of the handle part 30 and easily dispenses bags. However, as is understood, any one of the pockets (or multiple pockets) can be used or configured to hold the unused bag roll. As shown in FIG. 2, the collapsible pocket 12 (or pockets) configured to hold the unused bag roll can include an opening 42 in a portion thereof. The opening 42 is configured to enable an object to pass from an interior of the collapsible pocket 12 to an exterior. This, as can be understood, an unused bag roll B can be positioned within the collapsible pocket 12. One end of the unused bag roll B can be fed through the opening 42, and the collapsible pocket 12 can then be closed using the closure mechanism 40. Accordingly, when an animal walker or leash 10 user is desirous of using a bag B from the unused bag roll, the user merely pulls the remainder of the bag through the opening 42 and tears the bag off along the perforation. The remainder of the unused bag roll remains within the collapsible pocket 12.

In one embodiment, the front side portion 14c (or any other suitable portion) of the strap portion 14 and the handle part 30 can have decorative/designer material while rear side portion 14d of the leash 10 can be a more durable material. It is noted that the decorative/designer material can be indicia disposed on any portion of the leash 10 desired.

The leash 10 as described herein is advantageous because it provides a designer leash with an array of built-in and collapsible storage pockets 12 within the handle part 30 or trunk 14. Side coupling/closure materials such as zippers preserve the opportunity for an array of designer fabrics and finishes to the top of the leash. Generous accordion or expandable stretch pockets flatten when not in use and expand when needed for storage. A dedicated storage pocket for bag rolls provides a comfortable leash grip and a dispenser hole allows for easy access to new bags when needed. Animal walkers never have to carry soiled waste bags in hand and have generous accommodations for toys, treats and personal items.

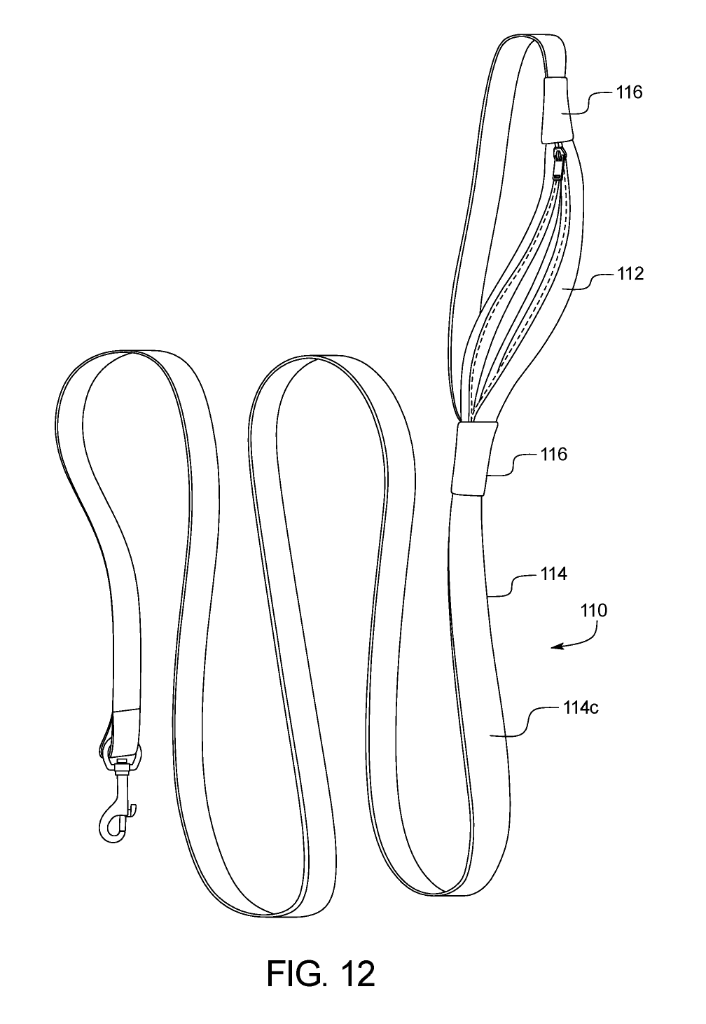

In another embodiment shown in FIG. 12, the leash 110 includes a pocket 112 that can be connected to the strap portion 114 with coupling members 116. Such a configuration is advantageous when the front side portion 114c of the strap portion 114 is narrow, for example, ⅜ inch or less. The coupling members can be any suitable coupling members that would enable the pocket to be attached to the strap portion permanently (e.g., stitching), while helping to gather and secure the top and bottom portions of the pockets to the narrow width of the leash. The remainder of the leash is similar to the description above.

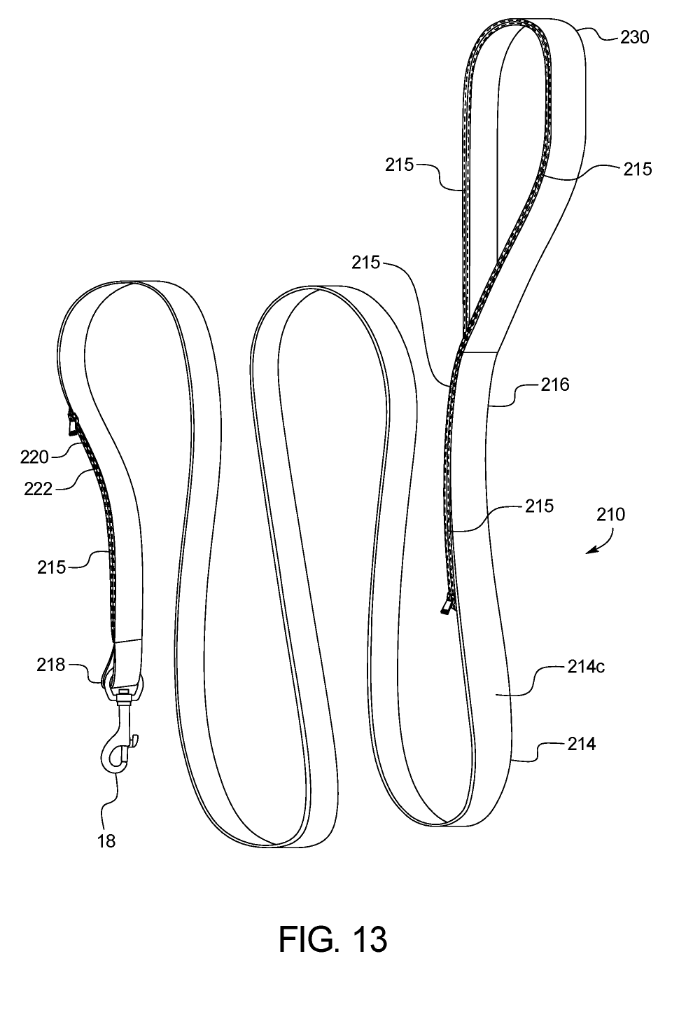

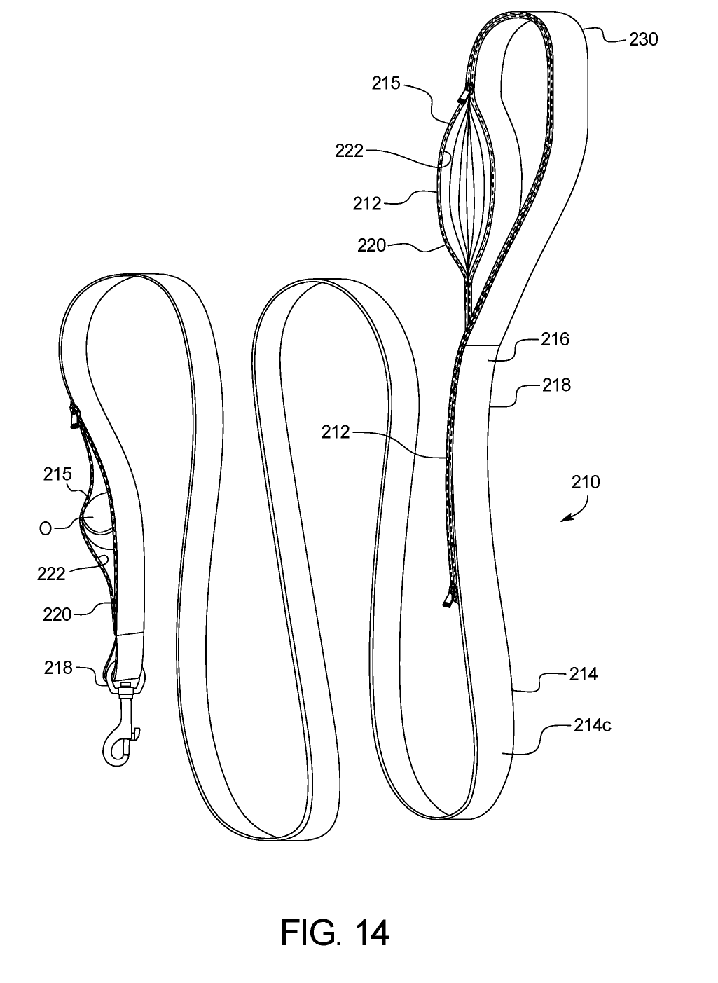

FIGS. 13 and 14 illustrate another embodiment of a leash 210. In this embodiment, the leash 210 can include a plurality of pocket attachments 215 that can be disposed at a variety or location along the leash 210. Thus, the pocket attachments 215 can be disposed on the truck part 216, the handle part 230 or the strap portion 214 or in any combination of these areas.

The pocket attachments 215 can each include a flexible strip 220 made from a material similar to or different from the strap portion. Generally, the flexible strip is attached to the leash at one end and the remainder of the flexible strip can be detachable from the leash 210. However, if desired the entire flexible strip can be removable. The flexible strip 220 can be formed from leather or nylon cloth or any other suitable material. In one embodiment, the flexible strip 220 can be attached to the strap portion 214 using a hook and loop structure (e.g., Velcro). That is, the flexible strip 220 has one of the hooks or loops disposed on a side 222 and the front side portion 214c has the other of the hooks and loops disposed thereon. Thus, the pocket 214c can be removed and reattached. As shown in FIG. 12, the strap can be opened and an object O (e.g., a ball or any other suitable object) can be disposed between the strap portion 214 and the flexible strip 220 forming pocket 215. As shown in FIG. 12, a collapsible pocket 212 can be inserted into the pocket attachment to form a detachable collapsible pocket. In this embodiment, the collapsible pocket can have a hook and loop configuration to match the hook and loop configuration of the flexible strip, enabling a secure fixing of the collapsible pocket 212 to the leash 210. This configuration enables the pocket attachments 215 to be adaptable to various sizes and configurations, enabling secure placement of any sized object in the pocket attachments 215. The remainder of the leash is similar to the description above. Collapsible pocket 212 can be similar to pocket 12 described herein.

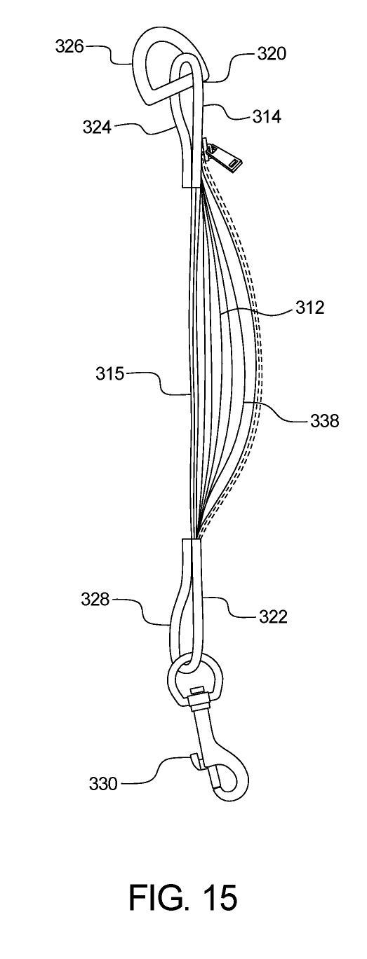

FIG. 15 illustrates a leash attachment 315 according to another embodiment. Leash attachment 315 can include a collapsible pocket 312 and a strap portion 314. In this embodiment, the leash attachment 315 can be a separate member that attaches to a conventional leash or any leash described herein. That the leash attachment 315 has a first end 320 and a second end 322. The first end has a loop portion 324 with a coupling mechanism 326 disposed in the loop portion that is configured to couple to an attachment portion of a leash (e.g. attachment portion 16). In one embodiment, the coupling mechanism 326 is a metal D-ring, but can be any suitable device. The second end 322 has a loop portion 328 this an attachment portion 330 that is similar to attachment portion 16. Thus, as can be understood, the leash attachment 315 can function as a leash extension portion.

In this embodiment, the collapsible pocket 312 is substantially similar to the pocket 12 described herein. Thus, in one embodiment, the collapsible pocket 312 can be a single pocket or one pocket of a plurality of pockets. Collapsible pocket 312 is preferably constructed using nylon accordion pleats 338 that enable the collapsible pocket 312 to collapse. That is, the material in the collapsible pocket 312 is formed in a zig zag manner that enables the pocket material to fold upon itself.

It is noted that the collapsible pocket 312 can be constructed in any suitable manner, such as any one or more of a variety of collapsed and extremely expandable fabrics that stretch to accommodate an array of storage items and then collapse down neatly. Thus, as is understood, the collapsible pocket 312 is capable of expanding to accommodate an array of storage items and collapse when not in use.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms, “top” and “bottom” as well as any other similar directional terms refer to those directions of a leash with collapsible pockets. Accordingly, these terms, as utilized to describe the present invention should be interpreted relative to a vehicle equipped with the leash with collapsible pockets.

The terms of degree such as, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents

What is claimed is:

1. A leash, comprising:
a strap portion having a front portion having a width and a side portion;
an attachment portion configured to enable the strap portion to be attached to an animal; and
a collapsible pocket attached to the strap portion and configured to be selectively opened along the side portion of the strap portion, the collapsible pocket having a width in a collapsed state that is less than the width of the front portion of the strap portion.

2. The leash of claim 1, wherein
the strap portion includes a handle part, and the collapsible pocket is disposed on the handle part.

3. The leash of claim 2, wherein
the collapsible pocket is integral with the handle part.

4. The leash of claim 1, wherein
the collapsible pocket is a first pocket of a plurality of pockets arranged in series along the strap portion.

5. The leash of claim 1, wherein
the collapsible pocket includes an opening configured to enable an object to pass from an interior of the collapsible pocket to an exterior.

6. The leash of claim 1, wherein
the collapsible pocket has a zig zag configuration.

7. The leash of claim 1, wherein
the collapsible pocket is formed from a stretchable material.

8. The leash of claim 1, wherein
the collapsible pocket has a closure mechanism.

9. The leash of claim 8, wherein
the closure mechanism is a zipper.

10. The leash of claim 1, wherein
the collapsible pocket is detachable from the strap portion.

11. The leash of claim 1, wherein
the strap portion includes a first layer and a second layer and the collapsible pocket is disposed between the first layer and the second layer.

12. The leash of claim 1, wherein
the collapsible pocket is a first pocket of a plurality of pockets arranged in series along a handle part of the strap portion.

13. The leash of claim 12, wherein
a second pocket of the plurality of pockets includes an opening configured to enable an object to pass from an interior of the collapsible pocket to an exterior

14. The leash of claim 12, further comprising
a closure mechanism configured to selectively open and close each of the plurality of pockets.

15. The leash of claim 12, wherein
the strap includes a first layer and a second layer and each of the plurality of pockets is disposed between the first layer and the second layer.

16. The leash of claim 1, wherein
the collapsible pockets are configured to expand at least three times the width of the first collapsible pocket in the collapsed state.

17. A leash extension, comprising:
a strap portion having a first end and a second end, the first end having a coupling mechanism configured to couple to a leash and the second end having an attachment portion configured to enable the strap portion to be attached to an animal; and
a collapsible pocket attached to the strap portion and configured to be selectively opened and expand such that the pocket is at least 3 times as large in an expanded state relative to a collapsed state.

18. A leash, comprising:
a strap portion; and
a detachable strip configured to detachably attach to the strap portion so as to form a pocket attachment configured to hold an object.
